(19) United States
(12) Patent Application Publication
(10) Pub. No.: US 2008/0214722 A1
(43) Pub. Date: Sep. 4, 2008

(54) Coating Agent With High Abrasion Resistance Method For Production And Application Thereof

(75) Inventors: Harald Petri, Aarbergen (DE); Ivan Cabrera, Dreieich (DE)

Correspondence Address: CONNOLLY BOVE LODGE & HUTZ, LLP, P O BOX 2207, WILMINGTON, DE, 19899, US

(73) Assignee: Celanese Emulsions GmbH, Kronberg/Ts. (DE)

(21) Appl. No.: 11/912,066

(22) PCT Filed: Apr. 10, 2006
(86) PCT No.: PCT/EP2006/003254

§ 371 Date: Apr. 25, 2008

(30) Foreign Application Priority Data
Apr. 20, 2005 (DE) 10 2005 018 129.5

(51) Int. Cl. C08L 23/00

(52) U.S. Cl. 524/528

(57) ABSTRACT

A description is given of coating compositions comprising at least one pigment and/or filler and at least one aqueous dispersion of a selected emulsifier-stabilized vinyl ester copolymer which comprises as its stabilizer a mixture of at least one nonionic emulsifier and at least one salt of a bisester of a sulfonated dicarboxylic acid having 4 to 8 carbon atoms.

The coating compositions formulated with these binders feature high scrub resistance.

The present invention relates to new coating compositions which comprise improved polyvinyl ester dispersion binders. The polymer dispersions used in accordance with the invention can be used to formulate coating compositions which feature a high scrub resistance.

With regard to the preparation of polymer dispersions the prior art has already proposed a very wide variety of emulsifiers. For instance, CH-A-436,721 describes a process for preparing lattices by emulsion polymerization of vinyl esters in the presence of an alpha,beta-unsaturated monocarboxylic acid. Anionic emulsifiers said to be suitable include salts of sulfosuccinic esters. In DE-A-198 01 442 a method is disclosed of improving the stability of aqueous polymer dispersions with respect to thermal and/or mechanical exposures, that comprises adding at least one salt of a bis-C₄-C₁₈ alkyl ester of a sulfonated dicarboxylic acid having 4-8 carbon atoms to the aqueous polymer dispersion.

Coating compositions, such as emulsion paints (dispersion-based), are used in both interior and exterior architectural preservation. Paints must be scrub-resistant in order to ensure a long lifetime.

The prior art has disclosed different approaches to improving the scrub resistance of paints.

WO-A-98/33,831, for instance, describes a dispersion prepared by two-stage polymerization and used as a binder for the formulation of coating compositions. The two-stage polymers are composed of a soft phase and a hard phase and also of a small fraction of copolymerized monomer units containing carboxyl groups. In the examples, styrene acrylates are described. The use of these binders results in improved blocking resistance and scrub resistance of the coatings.

U.S. Pat. No. 5,527,853 discloses a storage-stable and quick-curing aqueous coating composition. This composition comprises an anionically stabilized emulsion polymer, a selected water-soluble polyfunctional amine polymer, and a volatile base.

U.S. Pat. No. 6,242,531 describes an aqueous miniemulsion based on acrylic resin that can be used as a thickener in emulsion paints.

U.S. Pat. No. 6,646,058 describes an aqueous paint which exhibits improved hiding power and scrub resistance. The paint comprises an acidic core-shell polymer and also a selected copolymer and pigment.

WO-A-99/36,444 discloses a method of improving the stability of aqueous polymer dispersions to thermal and/or mechanical exposures. The process involves adding selected sulfonated dicarboxylic esters, such as sulfosuccinic esters, for example, to the polymer dispersion. Described principally is the stabilization of polyacrylate dispersions. Although selected vinyl esters are described as possible modifying comonomers, the disclosure does not encompass polyvinyl esters.

It is an object of the present invention to provide an aqueous emulsion paint comprising a binder based on vinyl ester polymers which can be processed to give paints having very good scrub resistance.

It has now been found, surprisingly, that through the use of selected binders it is possible to achieve the aforementioned object.

The invention provides coating compositions comprising
a) at least one pigment and/or filler, and
b) at least one aqueous dispersion of an emulsifier-stabilized vinyl ester polymer which has been copolymerized with ethylenically unsaturated monomers containing silane groups and/or with ethylenically unsaturated epoxide compounds and/or which has been modified with amino silanes or epoxy silanes, and which comprises as its stabilizer a mixture of at least one nonionic emulsifier and at least one salt of a bisester, preferably of a bis-C₄-C₁₈ alkyl ester, of a sulfonated dicarboxylic acid having 4 to 8 carbon atoms.

As component a) the coating composition of the invention comprises pigments and/or fillers. These are finely divided solids which are organic or inorganic in nature and are colored or uncolored.

Examples of pigments are inorganic pigments, such as inorganic oxides or inorganic sulfides, or carbon black or organic pigments. Preferred examples of pigments are titanium dioxide, zinc oxide, zinc sulfide, iron oxides and/or carbon black or organic pigments. Particularly preferred is titanium dioxide.

Examples of fillers are carbonates, such as dolomite, calcite, and chalk. Further examples are silicates, such as talc, kaolin, china clay, and mica. Preference is given to calcium carbonate and mica.

Particularly preferred components a) are titanium dioxide and/or calcium carbonate.

The fraction of component a) in the coating composition of the invention is typically 22% to 70%, preferably 32% to 60%, more particularly 45% to 60%, by weight, based on the total solids content.

The vinyl ester polymer component b) is a polymer which is prepared by free-radical emulsion polymerization and contains at least 40 mol %, based on the total amount of the monomers used, of vinyl ester monomer or a mixture of vinyl ester monomers, the vinyl ester polymer having been copolymerized with ethylenically unsaturated monomers containing silane groups and/or with ethylenically unsaturated epoxide compounds and/or the vinyl ester polymer having been modified with amino silanes or epoxy silanes.

The vinyl esters involve typically those of aliphatic, saturated carboxylic acids having a chain length of C₁-C₄.

Vinyl ester polymers used with preference are derived from
A1) vinyl esters of aliphatic, saturated carboxylic acids having a chain length of C₁-C₄,
A2) alpha-olefins having 2 to 8 carbon atoms, and/or
A3) vinyl esters of aliphatic, saturated carboxylic acids having a chain length of C₅-C₁₈, more particularly vinyl esters of a-branched carboxylic acids having 5 to 11 carbon atoms in the acid radical (®Versatic acids), and
A4) ethylenically unsaturated monomers containing silane groups and/or ethylenically unsaturated epoxide compounds, and also
A5) if desired, further comonomers,
   the sum of the monomers of types A1, A4, A2 and/or A3 and, if desired, A5 making 100% by weight.

The preferred vinyl ester copolymers are derived preferably from monomers of types A1, A2, A4, and, if desired, A5) or A1, A3, A4, and, if desired, A5) or more preferably from monomers of types A1, A2, A3, A4, and, if desired, A5).

The vinyl esters A1 of aliphatic saturated carboxylic acids of chain length C₁-C₄ are vinyl esters of straight-chain or branched aliphatic carboxylic acids, examples being vinyl formate, vinyl acetate, vinyl propionate, vinyl butyrate or vinyl isobutyrate. Vinyl acetate is preferred. In the polyvinyl ester the vinyl esters A1 may also be present in a combination of two or more of them alongside one another.

The fraction of the monomers A1, where appropriate in combination with further comonomers from this group, is 40% to 95%, preferably 50% to 76%, by weight, based on the total amount of the monomers used.

The alpha-olefins having 2 to 8 carbon atoms, A2, are branched or straight-chain alpha-olefins, examples being prop-1-ene, but-1-ene, pent-1-ene, hex-1-ene, hept-1-ene, oct-1-ene, and, more particularly, ethylene.

The fraction of the monomers A2, where appropriate in combination with further comonomers from this group, is 0% to 45%, preferably 5% to 45%, more preferably 8% to 25%, very preferably 10% to 20%, by weight, based on the total amount of the monomers used.

The vinyl esters A3 of aliphatic saturated carboxylic acids of chain length C₅-C₁₈ are vinyl esters of straight-chain or, preferably, of branched aliphatic carboxylic acids, examples being vinyl esters of α-branched carboxylic acids having 5 to 11 carbon atoms in the acid radical (®Versatic acids), the vinyl esters of pivalic, 2-ethylhexanoate, lauric, palmitic, myristic, and stearic acid. Vinyl esters of Versatic acids, more particularly VeoVa® 9, VeoVa® 10, and VeoVa® 11, are preferred. Within the polyvinyl ester the vinyl esters A3 may also be present in a combination of two or more of them alongside one another.

The fraction of the monomers A3, where appropriate in combination with further comonomers from this group, is 2% to 60%, preferably 2% to 40%, more preferably 4% to 30%, very preferably 5% to 25%, by weight, based on the total amount of the monomers used.

The ethylenically unsaturated monomers A4 containing silane groups are typically monomers of the formula RSi(CH₃)₀₋₂(OR¹)₃₋₁, where R has the definition CH₂═CR²—(CH₂)₀₋₁ or CH₂═CR²CO₂—(CH₂)₁₋₃, R¹ is an unbranched or branched, unsubstituted or substituted alkyl radical having 1 to 12 carbon atoms, which if desired can be interrupted by an ether group, and R² is H or CH₃.

Preference is given to silanes of the formulae CH₂═CR²—(CH₂)₀₋₁Si(CH₃)₀₋₁(OR¹)₃₋₂ and CH₂═CR²CO₂—(CH₂)₃Si(CH₃)₀₋₁(OR¹)₃₋₂, R¹ being a branched or unbranched alkyl radical having 1 to 8 carbon atoms and R² being H or CH₃.

Particularly preferred silanes are vinylmethyldimethoxysilane, vinylmethyldiethoxysilane, vinylmethyldi-n-propoxysilane, vinylmethyldiiso-propoxysilane, vinylmethyldi-n-butoxysilane, vinylmethyldi-sec-butoxy-silane, vinylmethyldi-tert-butoxysilane, vinylmethyldi(2-methoxyisopropyloxy)silane, and vinylmethyldioctyloxysilane.

More particularly preferred are silanes of the formula CH₂═CR²—(CH₂)₀₋₁Si(OR¹)₃ and CH₂═CR²CO₂—(CH₂)₃Si(OR¹)₃, R¹ being a branched or unbranched alkyl radical having 1 to 4 carbon atoms and R² being H or CH₃.

Examples thereof are γ-(meth)acryloyloxypropyltris(2-methoxyethoxy)-silane, γ-(meth)acryloyloxypropyltrismethoxysilane, γ-(meth)acryloyloxy-propyltrisethoxysilane, γ-(meth)aryloyloxypropyltris-n-propoxysilane, γ-(meth)acryloyloxypropyltrisisopropoxysilane, γ-(meth)acryloyloxypropyl-trisbutoxysilane, γ-acryloyloxypropyltris(2-methoxyethoxy)silane, γ-acryloyl-oxypropyltrismethoxysilane, γ-acryloyloxypropyltrisethoxysilane, γ-acryloyl-oxypropyltris-n-propoxysilane, γ-acryloyloxypropyltrisisopropoxysilane, γ-acryloyloxypropyltrisbutoxysilane, and also vinyltris(2-methoxyethoxy)-silane, vinyltrismethoxysilane, vinyltrisethoxysilane, vinyltris-n-propoxy-silane, vinyltrisisopropoxysilane, and vinyltrisbutoxysilane. The stated silane compounds may where appropriate also be used in the form of their (partial) hydrolysates.

Instead of or in addition to the ethylenically unsaturated silanes it is possible to use ethylenically unsaturated epoxide compounds, such as glycidyl methacrylate or glycidyl acrylate, as monomers A4.

The fraction of the monomers A4, where appropriate in combination with further comonomers of this group, is 0.1% to 10%, preferably 0.5% to 5%, by weight, based on the total amount of the monomers used.

Instead of or in addition to the monomers A4 it is possible to add further silanes, such as amino silanes or epoxy silanes, to the coating composition of the invention. This can be done during or, more particularly, after the preparation of the copolymer.

Suitable comonomers of group A5 preferably possess at least one stabilizing nonionic or ionic group, preferably an acid group, in the molecule, such groups providing the emulsion polymer with further stabilization by way of polymer-attached functional groups and/or charges.

Suitable comonomers A5 with stabilizing nonionic groups include, in particular, esters of ethylenically unsaturated aliphatic monocarboxylic and/or dicarboxylic acids with polyalkylene glycols, preferably with polyethylene glycols and/or polypropylene glycols, or esters of ethylenically unsaturated carboxylic acids with amino alcohols, such as (meth)acrylic esters of amino alcohols, of diethylaminoethanol, for example, and/or (meth)acrylic esters with dimethylaminoethanol, and also (meth)acrylic esters with dihydric aliphatic alcohols of chain length C₂-C₁₈ in which only one alcohol group is esterified. Additionally suitable are amides of ethylenically unsaturated carboxylic acids, such as amides of acrylic and methacrylic acid and N-methylol amides of acrylic and methacrylic acid, and also their ethers. A further group of these monomers are N-vinyl amides, including the N-vinyl lactams, an example being vinylpyrrolidone or N-vinyl-N-methylacetamide.

Suitable comonomers A5 with stabilizing ionic groups are ethylenically unsaturated carboxylic acids or sulfonic acids which have one or two carboxyl groups or one sulfonic acid group. In place of the free acids it is also possible to use their salts, preferably alkali metal salts or ammonium salts.

Examples of comonomers A5 are acrylic acid, methacrylic acid, crotonic acid, maleic acid, fumaric acid, itaconic acid, vinylsulfonic acid, styrenesulfonic acid, monoesters of maleic and/or fumaric acid and of itaconic acid with monohydric aliphatic saturated alcohols of chain length C₁-C₁₈, and also their alkali metal salts and ammonium salts, or (meth)acrylic esters of sulfoalkanols, an example being sodium 2-sulfoethyl methacrylate.

As further comonomers A5 which can be used in the copolymer it is possible to employ any desired comonomers not belonging to groups A1, A2, A3 or A4. Examples of such are esters of aliphatic carboxylic acids of chain length C₃-C₁₂ with unsaturated alcohols of chain length C₃-C₁₈, the acrylic and methacrylic esters of monohydric aliphatic saturated alcohols, vinyl chloride, vinylidene chloride, acrylonitrile and methacrylonitrile, butadiene, isoprene, C₉-C₁₆ alpha-olefins, 2-chlorobutadiene, 2,3-dichlorobutadiene, tetrafluoroethylene, styrene, vinyl ethers of monohydric aliphatic saturated alcohols of chain length C₁-C₁₈, divinyl esters and diallyl esters of saturated and unsaturated aliphatic dicarboxylic acids of chain length C₃-C₁₈, vinyl esters and allyl esters of acrylic acid and crotonic acid, and triallyl cyanurate. Preferred further comonomers A5 are acrylic esters of monohydric aliphatic saturated alcohols of chain length C₄-C₈ or C₁₄-C₁₆ alpha-olefins or butadiene.

The amount of any further comonomers A5 present, where appropriate in combination with further comonomers from this monomer group, is typically up to 10%, preferably up to 8%, by weight, based on the total copolymer composition A).

Within the polyvinyl ester the comonomers A5 may also be present in a combination of two or more of them alongside one another.

In addition to the abovementioned monomer groups A1, A2, A3, and A4 or A1, A2, and A4, or A1, A3, and A4 it is preferred to use at least one further comonomer of group A5, more particularly vinylsulfonic acid or its alkali metal salts.

Component b) is further characterized by the presence of a selected combination of emulsifiers. These are nonionic emulsifiers E1 and selected anionic emulsifiers E2. They are added even before or during the emulsion polymerization; portions thereof however, may also be added subsequently as well. The component b) used in accordance with the invention contains no protective colloid. The emulsion-stabilizing polymers, such as polyvinyl alcohol or cellulose ethers, are therefore not present during the emulsion polymerization. It is, however, possible for such components to be added subsequently.

Component b) preferably contains no emulsion-stabilizing polymers.

Examples of nonionic emulsifiers E1 are acyl, alkyl, oleyl, and alkylaryl oxethylates. These products are available commercially, for example, under the name Genapol® or Lutensol®. They include, for example, ethoxylated mono-, di-, and tri-alkylphenols (EO degree: 3 to 50, alkyl substituent radical: C₄ to C₁₂) and also ethoxylated fatty alcohols (EO degree: 3 to 80; alkyl radical: C₅ to C₃₆), especially C₁₂-C₁₄ fatty alcohol (3-8)ethoxylates, C₁₃C₁₅ oxo-process alcohol (3-30)ethoxylates, C₆C₁₈ fatty alcohol (11-80)ethoxylates, C₁₀ oxo-process alcohol (3-11)ethoxylates, C₁₃ oxo-process alcohol (3-20)ethoxylates, polyoxyethylenesorbitan monooleate with 20 ethylene oxide groups, copolymers of ethylene oxide and propylene oxide with a minimum ethylene oxide content of 10% by weight, the polyethylene oxide(4-20) ethers of oleyl alcohol, and the polyethene oxide(4-20) ether of nonylphenol. Particularly suitable are the polyethylene oxide(4-20) ethers of fatty alcohols, more particularly of oleyl alcohol.

Typically 0.1 to 5 parts by weight, preferably 0.5 to 3.0 parts by weight, based on the vinyl ester polymer, of nonionic emulsifiers E1 are used. Mixtures of nonionic emulsifiers E1 can also be used.

As a further component E2 of the emulsifier mixture, use is made of a salt of a bisester, preferably of a bis-C₄-C₁₈ alkyl ester, of a sulfonated dicarboxylic acid having 4 to 8 carbon atoms, or of a mixture of these salts.

These are preferably sulfonated salts of esters of succinic acid, more preferably salts, such as alkali metal salts, of bis-C₄-C₁₈ alkyl esters of sulfonated succinic acid.

Examples of particularly preferred emulsifiers of type E2 are alkali metal salts of sulfosuccinic esters with aliphatic saturated monohydric alcohols of chain length C₄-C₁₆, sulfosuccinic acid 4-esters with polyethylene glycol ethers of monohydric aliphatic alcohols of chain length C₁₀-C₁₂ (disodium salt), sulfosuccinic acid 4-esters with polyethylene glycol nonylphenol ether (disodium salt) or biscyclohexyl sulfosuccinate (sodium salt).

Typically 0.1 to 5.0 parts by weight, preferably 0.5 to 3.0 parts by weight, based on the vinyl ester polymer, of anionic emulsifiers E2 are used. Mixtures of anionic emulsifiers E2 can also be used.

In order to improve the stability further it is also possible to use other anionic stabilizers E3 as well, as coemulsifiers. Mention may be made, by way of example, of sodium, potassium, and ammonium salts of straight-chain aliphatic carboxylic acids of chain length C₁₂-C₂₀, sodium hydroxyoctadecanesulfonate, sodium, potassium, and ammonium salts of hydroxy fatty acids of chain length C₁₂-C₂₀ and their sulfonation and/or acetylation products, alkyl sulfates, including those in the form of triethanolamine salts, alkyl-(C₁₀-C₂₀)-sulfonates, alkyl-(C₁₀-C₂₀)-arylsulfonates, dimethyldialkyl(C₈-C₁₈)-ammonium chloride, and their sulfonation products, lignosulfonic acid and its calcium, magnesium, sodium, and ammonium salts, resin acids, hydrogenated and dehydrogenated resin acids, and their alkali metal salts, dodecylated sodium diphenyl ether disulfonate, and sodium lauryl sulfate, or ethoxylated sodium lauryl ether sulfate (EO degree 3).

Typically 0 to 5.0 parts by weight, preferably 0 to 3.0 parts by weight %, based on the vinyl ester polymer, of additional ionic emulsifiers E3 are used. Mixtures of these additional anionic emulsifiers E3 can also be used.

The fraction of emulsifiers, based on the vinyl ester polymer, is typically 0.2 to 10 parts by weight, preferably 0.5% to 5.0% by weight, based on the vinyl ester polymer.

The weight fraction of emulsifiers E1 to E2 can vary within wide ranges, such as between 1:10 and 10:1, for example.

The fraction of component b) in the coating composition of the invention is typically 6% to 55%, preferably 15% to 30%, by weight, based on the total solids content.

The aqueous polyvinyl ester dispersions used in accordance with the invention typically possess solids contents of 20% to 70%, preferably 30% to 65%, and more preferably 40% to 60% by weight.

Preference is given to those coating compositions wherein the vinyl ester polymer is derived from monomers of the above-defined types A1, A2, A4, and, if desired, A5, and wherein the monomer of type A2 is ethylene. One particularly preferred copolymer from this group is a vinyl acetate-ethylene copolymer which had been modified with monomers containing silane groups and/or with monomers containing epoxide groups.

Preference is further given to coating compositions wherein the vinyl ester polymer is derived from monomers of the above-defined type A1, A3, A4, and, if desired, A5, and wherein the monomer of type A3 is a vinyl ester of a-branched carboxylic acids having 9 to 11 carbon atoms in the acid radical (®Versatic acid) and which has been modified with monomers containing silane groups and/or with monomers containing epoxide groups.

Particularly preferred coating compositions comprise polymer dispersions wherein the stabilizer mixture makes up 1% to 10% by weight, based on the monomers used, and wherein the weight ratio of nonionic emulsifier to ionic emulsifier is 1:10 to 10:1.

If desired, the coating compositions of the invention further comprise typical additions c).

As additives and further constituents it is possible to use film-forming assistants, such as white spirit, Texanol®, TxiB®, butylglycol, butyldiglycol, butyldipropylene glycol, and butyltripropylene glycol; plasticizers, such as dimethyl phthalate, diisobutyl phthalate, diisobutyladipate, Coasol B®, and Plastilit 3060®; wetting agents, such as AMP 90®, TegoWet.280®, and Fluowet PE®; thickeners, such as polyacrylates or polyurethanes, such as Borchigel L75® and Tafigel PUR 60®; defoamers, e.g., mineral oil defoamers or silicone defoamers; UV stabilizers, such as Tinuvin 1130®, stabilizing polymers added subsequently, such as polyvinyl alcohol or cellulose ethers, and other additives and auxiliaries of the type typical for the formulation of coating materials.

The fraction of component a) in the coating composition of the invention can be up to 25%, preferably 2% to 15%, and more particularly 5% to 10%, by weight, based on the total solids content.

The minimum film-forming temperature of the coating compositions of the invention is typically below 25° C., preferably below 15° C. The film-forming temperature can be modified and tailored through the addition of conventional coalescents.

The invention also relates to a process for preparing the aqueous coating compositions described above. This process encompasses preparing a polyvinyl ester dispersion which has been copolymerized with ethylenically unsaturated monomers containing silane groups and/or with ethylenically unsaturated epoxide compounds and/or which has been modified with amino silanes or epoxy silanes, by free-radical emulsion polymerization in the presence of an emulsifier mixture comprising at least one nonionic emulsifier and at least one salt of a bisester, preferably of a bis-C₄-C₁₈ alkyl ester, of a sulfonated dicarboxylic acid having 4 to 8 carbon atoms, and conventional mixing of the above-defined components a), b), and, if desired, ca), accomplished by means for example of the stirring-together of the copolymer dispersion described, together with a pigment/filler paste, at 1500 rpm by means of a Lenard stirrer.

One particularly preferred embodiment of the process of the invention encompasses preparing component b) by free-radical emulsion polymerization to give a vinyl acetate-ethylene copolymer which has been modified with monomers containing silane groups and/or with monomers containing epoxide groups, in the presence of a stabilizer mixture composed of at least one nonionic emulsifier and at least one salt of a bisester of a sulfonated dicarboxylic acid having 4 to 8 carbon atoms.

Component b) is typically prepared by free-radical emulsion polymerization. This can be carried out in a batch process, in a feed process, in a combined batch/feed process or in a continuous process.

It is nevertheless preferred to operate in a combined batch/feed process or, with preference, in a feed process, in which case typically a portion of the monomers (1% to 15% by weight) is introduced initially at the start of the polymerization. The monomers can be metered either together or in separate feeds. It may additionally be advantageous to carry out a seed polymerization in certain embodiments for the purpose of setting specific particle sizes and particle-size distributions.

Examples of free-radical initiators used include the following: hydrogen peroxide, benzoyl peroxide, cyclohexanone peroxide, isopropyl cumyl hydroperoxide, persulfates of potassium, of sodium, and of ammonium, peroxides of even-numbered saturated monobasic aliphatic carboxylic acids of chain length C₈-C₁₂, tert-butyl hydroperoxide, di-tert-butyl peroxide, diisopropyl percarbonate, azoisobutyrodinitrile, acetyl cyclohexanesulfonyl peroxide, tert-butyl perbenzoate, tert-butyl peroctoate, bis(3,5,5-trimethyl-hexanoyl) peroxide, tert-butyl perpivalate, hydroperoxypinane, p-menthane hydroperoxide. The aforementioned compounds can also be used within redox systems, in which case transition metal salts such as iron(II) salts or other reducing agents are used. As reducing agents or regulators it is possible to use alkali metal salts of oxymethanesulfinic acid, mercaptans of chain length C₁₀-C₁₄, buten-1-en-3-ol, hydroxylamine salts, sodium dialkyldithiocarbamate, sodium bisulfite, ammonium bisulfite, sodium dithionite, diisopropylxanthogen disulfide, ascorbic acid, tartaric acid, isoascorbic acid, boric acid, urea, and formic acid.

It is nevertheless preferred to use water-soluble persulfates, more particularly ammonium persulfate or sodium persulfate, to start the polymerization.

The emulsifier mixture used for stabilization can likewise be added either completely at the beginning of the polymerization or else included partly in the initial charge and partly metered in, or metered in completely during the polymerization.

The pH of the dispersion is typically between 2 and 7, preferably between 2.5 and 6.

The polymerization temperature is situated typically in the range from 20 to 120° C., preferably in the range from 30 to 110° C., and very preferably in the range from 45 to 95° C.

The polymerization may be followed, for the purpose of demonomerization, by a further aftertreatment, preferably a chemical aftertreatment, more particularly with redox catalysts, such as combinations of the above-mentioned oxidizing agents and reducing agents, for example. Additionally it is possible to remove residual monomer in a known way: for example, by physical demonomerization, i.e., distillative removal (more particularly by way of steam distillation), or by stripping with an inert gas. Particularly efficient is a combination of physical and chemical methods, which allows the residual monomers to be lowered to very low levels (<1000 ppm, preferably <100 ppm).

The aqueous coating compositions of the invention are suitable to coat substrates of all kinds, taking the form, for example, of paints, preferably in the architectural sector.

These uses are likewise provided by the present invention.

The invention further provides for the use of the above-defined aqueous vinyl ester dispersions as binders for aqueous coating compositions, more particularly for aqueous emulsion paints.

The examples below serve to illustrate the invention. The parts and percentages stated in the examples are by weight unless noted otherwise.

### COMPARATIVE EXAMPLE 1

### Preparation of a Noninventively Usable Vinyl Acetate/Ethylene Copolymer Dispersion with Subsequent Elimination of Residual Monomer

A pressure apparatus with stirrer, jacket heating, and metering pumps was charged with an aqueous solution composed of the following constituents:

22 000 g of water, 86 g of sodium acetate, 1440 g of a 70% strength by weight aqueous solution of an oxo-process alkyl ethoxylate with 28 mol of ethylene oxide, 2160 g of a 10% strength by weight aqueous polyvinyl alcohol solution (viscosity of the 4% strength by weight aqueous solution 18 mPa s), 1127 g of a 15% strength by weight sodium lauryl sulfate solution, 577 g of a 30% strength by weight aqueous sodium vinylsulfonate solution, and 8 g of a 1% strength by weight aqueous solution of Fe-II(SO₄)×7H2O. The pH of the solution was 7.2. The apparatus was freed from atmospheric oxygen and injected with ethylene. At an ethylene pressure of 20 bar, 1500 g of vinyl acetate were metered in. Heating took place to an internal temperature of 60° C., and in the course of the heating the ethylene pressure was raised to 40 bar. Then 10% of a solution of 27.1 g of Brüggolit C in 2000 g of water was metered in. Subsequently 10% of a solution of 27.1 g of tert-butyl hydroperoxide in 2000 g of water was metered in at an internal temperature of 60° C., and cooling was carried out to take off the heat of reaction. A mixture of 28 800 g of vinyl acetate and 70 g of vinyltrimethoxysilane (VTM) and the remaining 90% of the reducing solution and initiator solution were subsequently metered in, the ethylene pressure being held at 40 bar until 4135 g of ethylene were in the reactor. Thereafter a solution of 36 g of sodium persulfate in 600 g of water was metered in and the internal temperature was raised to 80° C. and held at that temperature for 1 hour. Subsequently, with stirring, the major part of the unreacted ethylene was removed, and 2 l of water were added. Then, with a vacuum being applied, 2 l of water were distilled off over the course of 2 hours, thereby reducing the residual vinyl acetate content of the dispersion to 0.05% by weight, based on the dispersion. Repeating the separation procedure gave a residual vinyl acetate content of 0.012% by weight. Some properties of the dispersion obtained are set out in table 1.

### INVENTIVE EXAMPLES 2-10

### Preparation of an Inventively Useful Vinyl Acetate-Ethylene or Vinyl Acetate-VeoVa10 Copolymer Dispersion with Subsequent Elimination of Residual Monomers and Other Volatile Constituents

Polymerization was carried out in the same apparatus and by same method as in comparative example 1, with a different composition, which is set out in the table below, and with 1127 g of a 15% strength by weight sodium lauryl sulfate solution being replaced by an Na salt of a sulfosuccinic ester (all numerical values denote % by weight solids based on vinyl acetate/VeoVa10 or on vinyl acetate/ethylene).

TABLE 1
Composition of polymer dispersions prepared

| | | | | | | | Oxo- | |
|---|---|---|---|---|---|---|---|---|
| | | | | | | | process | Na |
| | | | | Na | | Poly- | alkyl | sulfo- |
| | Vinyl | | | vinyl- | | vinyl | ethoxylate- | succi- |
| | acetate | VeoVa10 | Ethylene | sulfonate | VTM | alcohol | 28EO | nate |
| C1 | 88 | 0 | 12 | 0.5 | 0.2 | 0.6 | 3 | 0 |
| 2 | 88 | 0 | 12 | 0.5 | 0.2 | 0 | 3 | 1 |
| 3 | 88 | 0 | 12 | 0.5 | 0.2 | 0 | 2 | 1 |
| 4 | 88 | 0 | 12 | 0.5 | 0.2 | 0 | 3 | 1.75 |
| 5¹⁾ | 88 | 0 | 12 | 0.5 | 0.2 | 0 | 3 | 1 |
| 6 | 75 | 25 | 0 | 0.5 | 0.2 | 0 | 0.5 | 3 |
| 7 | 75 | 25 | 0 | 0.5 | 0.2 | 0 | 2 | 1 |
| 8 | 75 | 25 | 0 | 0.75 | 0.2 | 0 | 3 | 3 |
| 9 | 75 | 25 | 0 | 0.75 | 0.2 | 0 | 0.5 | 0.5 |
| 10 | 75 | 25 | 0 | 0.5 | 0.2 | 0 | 3 | 0.5 |

¹⁾Polymerized at 50° C.

TABLE 2
Physical properties of polymer dispersions prepared

| | Solids % | Particle size [nm] |
|---|---|---|
| C1 | 54 | 200 |
| 2 | 54.1 | 163 |
| 3 | 54.2 | 159 |
| 4 | 54 | 147 |
| 5 | 53.6 | 144 |
| 6 | 53.8 | 189 |
| 7 | 53.7 | 187 |
| 8 | 53.5 | 146 |
| 9 | 52.3 | 233 |
| 10 | 53.4 | 185 |

As compared with a dispersion stabilized using protective colloid, the polyvinyl ester dispersion used in accordance with the invention is distinguished by a lower average particle size and by a narrower particle-size distribution. Using the soft dispersions C1 and 2-5, paints were prepared in a solvent-free formula (table 3), and, using the hard dispersions, paints were prepared in a solventborne formula (table 5).

### APPLICATION EXAMPLES

The invention is described in more detail below through the formulation of emulsion paints having the composition below:

TABLE 3

| Constituents | Parts by weight |
|---|---|
| Water | 301.5 |
| Dispersant (sodium polyphosphate, 10% strength | 5.0 |
| solution) | |
| Cellulose ether (type MH, high viscosity) | 4.0 |
| Dispersant, Na salt of a polyacrylic acid | 3.5 |
| Mineral oil-based defoamer | 2.0 |
| 10% strength aqueous sodium hydroxide solution | 2.0 |
| Titanium dioxide pigment | 80.0 |
| Filler, calcium carbonate, particle size 2 μm | 235.0 |
| Filler, calcium carbonate, particle size 5 μm | 205.0 |
| Aluminum silicate filler | 35.0 |
| Copolymer dispersion¹⁾ | 125.0 |
| Preservative | 2.0 |

¹⁾The copolymers of examples C1 and 2 to 5 were used (cf. table 1)

The methylhydroxyethylcellulose, in powder form, was scattered into the water and dissolved with stirring, after which the solutions of the Na salts of polyacrylic ester and polyphosphoric acid and the 10% strength by weight aqueous sodium hydroxide solution were added with stirring. The viscous solution obtained was admixed with the preservative and the defoamer. With stirring by means of a dissolver, initially at a stirring speed of 2000 rpm, aluminum silicate was incorporated, and then, with the stirrer speed raised to 5000 rpm, titanium dioxide and the calcium carbonate grades were added. Dispersion was continued at 5000 rpm for 20 minutes, the temperature of the pigment/filler paste rising to 60° C. Cooling took place to 30° C. The pH was 9.3.

In order to investigate the parameters of the copolymer dispersions described, 875 g of the pigment/filler paste was stirred together with 125 g of each of the copolymer dispersions under test (3 minutes, Lenard stirrer at 1500 rpm). This gave emulsion paints having a solids content of approximately 63% by weight and having a pigment volume concentration (PVC) of approximately 77%.

The scrub resistance of these paints was tested by means of the nonwoven pad method (ISO 11998). For this purpose the wear of the coating after 28 days' storage (28 d) was determined from the loss of mass of the paint film. The paint wear in μm was then calculated from the paint density, the surface areas scrubbed, and the loss of mass of the paint film.

The key characteristics of the different emulsion paints are scrub resistance (WSR) and hiding power. The test results are shown in table 4.

TABLE 4

| | WSR | |
|---|---|---|
| Copolymer of example | [μm] | Hiding power |
| C1 | 30 | 98.3 |
| 2 | 23 | 98.3 |
| 3 | 25 | 98.8 |
| 4 | 22 | 98.2 |
| 5 | 20 | 98.3 |

As mentioned above, the copolymers of examples 6 to 10 were used to prepare emulsion paints having the composition below:

TABLE 5

| | |
|---|---|
| Water | 285.5 |
| Dispersant (Na salt of a polyacrylic acid) | 3.0 |
| Cellulose ether MH 10 000 YP 2 | 4.5 |
| Dispersant (Na polyphosphate) 10% | 15.0 |
| Defoamer | 0.5 |
| Microtalc filler | 40.0 |
| Aluminum silicate filler | 40.0 |
| Kronos 2065 titanium dioxide | 70.0 |
| Calcium carbonate filler, particle size 5 μm | 440.0 |
| Preservative | 1.5 |
| Ammonia conc. (25%) | 0.5 |
| Copolymer dispersion | 80.0 |
| Texanol (solvent) | 20.0 |
| | 1000.0 |

The emulsion paints were prepared as described in the formula of table 3.

The test results are shown in table 6 below.

TABLE 6

| | WSR¹⁾ | |
|---|---|---|
| Copolymer of example | [μm] | Hiding power²⁾ |
| C1 | 35 | 98.3 |
| 6 | 26 | 98.5 |
| 7 | 23 | 98.3 |
| 8 | 25 | 98.8 |
| 9 | 28 | 98.2 |
| 10 | 29 | 98.3 |

¹⁾WSR = Scrub resistance; figures in μm
²⁾Hiding power determined in accordance with DIN ISO 6504-3

1-16. (canceled)

17. A coating composition comprising
a) at least one pigment and/or filler; and
b) at least one aqueous dispersion of an emulsifier-stabilized vinyl ester polymer which has been copolymerized with ethylenically unsaturated monomers containing silane groups and/or with ethylenically unsaturated epoxide compounds and/or which has been modified with amino silanes or epoxy silanes, and which comprises as its stabilizer a mixture of at least one nonionic emulsifier and at least one salt of a bisester of a sulfonated dicarboxylic acid having 4 to 8 carbon atoms.

18. The coating composition of claim 17, wherein said vinyl ester polymer is derived from monomers A1, A2, A4, and optionally A5, or from monomers A1, A3, A4, and optionally A5, or from monomers A1, A2, A3, A4, and optionally A5, wherein
A1 is vinyl esters of aliphatic, saturated carboxylic acids having a chain length of C₁-C₄;
A2 is alpha-olefins having 2 to 8 carbon atoms;
A3 is vinyl esters of aliphatic, saturated carboxylic acids having a chain length of C₅-C₁₈;
A4 is ethylenically unsaturated monomers containing silane groups and/or ethylenically unsaturated epoxide compounds; and
A5 is further comonomers;
wherein the sum of A1, A4, A2 and/or A3, and optionally A5 equals 100% by weight.

19. The coating composition of claim 18, wherein A1 is vinyl acetate.

20. The coating composition of claim 18, wherein said vinyl ester polymer is derived from monomers of A1, A2, A4 and optionally A5 and wherein the monomer of A2 is ethylene.

21. The coating composition of claim 20, wherein said vinyl ester polymer is a vinyl acetate-ethylene copolymer modified with monomers containing silane groups and/or with monomers A4 containing epoxide groups.

22. The coating composition of claim 18, wherein said vinyl ester polymer is derived from monomers of A1, A3, A4 and optionally A5, wherein the monomer of A3 is a vinyl ester of alpha-branched carboxylic acids having 9 to 11 carbon atoms in the acid radical.

23. The coating composition of claim 18, wherein said vinyl ester polymer comprises monomer units derived from ethylenically unsaturated monomers containing silane groups of A4, wherein monomer A4 is a silane of the formulae CH₂═CR²—(CH₂)₀₋₁Si(CH₃)₀₋₁(OR¹)₃₋₂ and/or CH₂CR2CO₂—(CH₂)₃Si(CH₃)₀₋₁(OR¹)₃₋₂, wherein R¹ is a branched or unbranched alkyl radical having up to 8 carbon atoms and R² being H or CH₃.

24. The coating composition of claim 18, wherein said vinyl ester polymer comprises monomer units derived from monomers with ethylenically unsaturated epoxide compounds of A4, wherein monomer A4 is a glycidyl methacrylate or glycidyl acrylate.

25. The coating composition of claim 17, wherein said nonionic emulsifier is selected from the group consisting of acyl, alkyl, oleyl, and alkylaryl oxethylates.

26. The coating composition of claim 25, wherein said nonionic emulsifier is selected from the group consisting of ethoxylated mono-, di-, and tri-alkylphenols, ethoxylated fatty alcohols, and copolymers of ethylene oxide and propylene oxide having a minimum ethylene oxide content of 10% by weight.

27. The coating composition of claim 17, wherein said salt of a bisester of a sulfonated dicarboxylic acid having 4 to 8 carbon atoms is a salt of bis-C₄-C₁₈ alkyl esters of sulfonated succinic acid.

28. The coating composition of claim 27, wherein said salt of a bisester of a sulfonated dicarboxylic acid having 4 to 8 carbon atoms is an alkali metal salt of bis-C₄-C₁₈ alkyl esters of sulfonated succinic acid.

29. The coating composition of claim 17, wherein said stabilizer mixture makes up 1% to 10% by weight, based on the monomers used, and the weight ratio of nonionic emulsifier to ionic emulsifier is 1:10 to 10:1.

30. The coating composition of claim 17, wherein a) is selected from the group consisting of inorganic oxides, inorganic sulfides, carbon black, inorganic carbonates, and organic pigments.

31. The coating composition of claim 29, wherein a) is selected from the group consisting of titanium dioxide, calcium carbonate, and mixtures thereof.

32. A process for producing aqueous emulsion paints of claim 17, comprising preparing a polyvinyl ester dispersion which has been copolymerized with ethylenically unsaturated monomers containing silane groups and/or with ethylenically unsaturated epoxide compounds and/or which has been modified with amino silanes or epoxy silanes, by free-radical emulsion polymerization in the presence of an emulsifier mixture comprising at least one nonionic emulsifier and at least one salt of a bisester of a sulfonated dicarboxylic acid having 4 to 8 carbon atoms, and mixing the resulting polyvinyl ester dispersion with at least one pigment and/or filler and optionally with her, conventional additives in a conventional way.

33. The process of claim 32, wherein said at least one salt of a bisester of a sulfonated dicarboxylic acid having 4 to 8 carbon atoms is a bis-C⁴-C₁₋₈ alkyl ester.

34. The process of claim 32, wherein said polyvinyl ester dispersion is a vinyl acetate-ethylene copolymer modified with monomers containing silane groups and/or with monomers A4 containing epoxide groups and prepared by free-radical emulsion polymerization in the presence of a stabilizer mixture composed of at least one nonionic emulsifier and at least one salt of a bis-C₄-C₁₃ alkyl ester of a sulfonated dicarboxylic acid having 4 to 8 carbon atoms.

35. A paint for use in the architectural sector comprising the coating composition of claim 17.
